(19) United States
(12) Patent Application Publication
(10) Pub. No.: US 2013/0300391 A1
(43) Pub. Date: Nov. 14, 2013

(54) CONTROLLER, CONTROLLING METHOD, AND DIGITAL DC-DC CONVERTER USING THE CONTROLLER AND THE CONTROLLING METHOD

(71) Applicant: FAIRCHILD KOREA SEMICONDUCTOR LTD., Bucheon (KR)

(72) Inventors: Sung-Pah LEE, Seoul (KR); Kun-Hee CHO, Seoul (KR); Woo-Kang JIN, Bucheon (KR)

(73) Assignee: FAIRCHILD KOREA SEMICONDUCTOR LTD., Bucheon (KR)

(21) Appl. No.: 13/889,579

(22) Filed: May 8, 2013

(30) Foreign Application Priority Data
May 8, 2012 (KR) 10-2012-0048814

(51) Int. Cl. H02M 3/157; H02M 3/156

(52) U.S. Cl. CPC H02M 3/157; H02M 3/156
USPC 323/283; 323/282

(57) ABSTRACT

An exemplary embodiment of the present invention generates a plurality of clock signals having a frequency according to an output voltage, a plurality of low clock signals of which frequencies are half of frequencies of the plurality of clock signals, and a phase signal corresponding to the output voltage by subtracting an average phase error from a count signal sampled by being synchronized with a reference clock signal from the count result of a first clock signal having the earliest phase among the plurality of clock signals. The average phase error is generated according to a comparison result of a first low clock signal corresponding to the first clock signal and each of other low clock signals among the plurality of low clock signals by being synchronized with the reference clock signal.

### CROSS-REFERENCE TO RELATED APPLICATION

This application claims priority to and the benefit of Korean Patent Application No. 10-2012-0048814 filed in the Korean Intellectual Property Office on May 8, 2012, the entire contents of which are incorporated herein by reference.

### BACKGROUND OF THE INVENTION

(a) Field of the Invention

The present invention relates to a digital DC-DC converter. In further detail, the present invention relates to a controller for controlling a digital DC-DC converter, and a control method.

(b) Description of the Related Art

A digital DC-DC converter uses a digital signal to maintain an output voltage with a constant level. Switching duty of the digital DC-DC converter is controlled according to a result of comparison of the digital signal indicating the output voltage and a reference digital signal. The reference digital signal indicates a target value of the output voltage.

A counter is required to generate the digital signal indicating the output voltage. Further the converter is required in plural to accurately realize an output voltage of an analog signal to a digital signal. For example, outputs of the plurality of counters are summed and then averaged such to generate a digital signal.

However, the counter is formed of a complex circuit and is large in size. Therefore, a circuit for controlling operation of the digital DC-DC converter is complicated, and the size of the circuit is increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a digital DC-DC converter formed of a further simple circuit, a control circuit that can reduce the control circuit in size, a control method of the same, and a digital DC-DC converter using the same.

A controller according to an exemplary embodiment of the present invention includes: a clock signal generation unit generating a plurality of clock signals, each having a frequency according to an output voltage; a division unit generating a plurality of low clock signals of which frequencies are half of frequencies of the plurality of clock signals; and a first subtractor generating a phase signal corresponding to the output voltage by subtracting an average phase error from a count signal sampled by being synchronized with a reference clock signal from the count result of a first clock signal having the earliest phase among the plurality of clock signals. The average phase error is generated according to a comparison result of a first low clock signal corresponding to the first clock signal and each of other low clock signals among the plurality of low clock signals by being synchronized with the reference clock signal.

The controller further includes a second subtractor generating an error phase signal by subtracting a reference phase signal corresponding to a target value of the output voltage from the phase signal.

When the number of bits for expression of digits after the decimal point of the reference phase signal is n, the number of the plurality of clock signals is 2̂n.

The controller further includes a counter counting the first clock signal and a count sampler sampling the count result output from the counter by being synchronized with the reference clock signal to generate the count signal.

The controller further includes a sampling unit sampling the plurality of low clock signals by being synchronized with the reference clock signal to generate a plurality of sampling signals and an error generation unit generating the average phase error by adding results of comparison of a first sampling signal generated by sampling a first low clock signal corresponding to the first clock signal among the plurality of sampling signals and other sampling signals and then dividing the sum result with the number of the plurality of clock signals.

The error generation unit includes: a plurality of XOR gates receiving the first sampling signal and a sampling signal corresponding to the other sampling signals and generating a plurality of out bits having values of 1 when the two inputs are equivalent to each other and 1 when the two inputs are different from each other; and an average calculation unit generating the average phase error by dividing a sum result of the plurality of out bits with the number of the plurality of clock signals.

The controller further includes a reference phase generator synchronized with the reference clock signal to update a reference phase signal by adding a reference phase unit to the present reference phase signal, and the reference phase unit is an increase unit of the reference phase signal.

A control method according to another exemplary embodiment of the present invention includes: generating a plurality of clock signals, each having a frequency according to an output voltage; generating a count signal by sampling a count result of a first clock signal having the earliest phase among the plurality of clock signals by being synchronized with a reference clock signal; generating a plurality of low clock signals, each having the half of a frequency of each of the plurality of clock signals; generating an average phase error according to a comparison result of a first low clock signal corresponding to the first clock signal with each of other clock signals among the plurality of low clock signals by being synchronized with the reference clock signal; and generating a phase signal corresponding to the output voltage by subtracting the average phase error from the count signal.

The control method further includes generating an error phase signal by subtracting a reference phase signal corresponding to a target value of the output voltage from the phase signal.

When the number of bits for expression of digits after the decimal point of the reference phase signal is n, the number of plurality of clock signals is 2̂n.

The generating the average phase error includes: generating a plurality of sampling signals by sampling the plurality of low clock signals by being synchronized with the reference clock signal; comparing a first sampling signal generated by sampling a first low clock signal corresponding to the first clock signal among the plurality of sampling signals with each of other sampling signals; and generating the average phase error by dividing a sum result of the comparison results with the number of the plurality of clock signals.

The comparing the first sampling signal with each of other sampling signals includes: generating an output bit of 0 when the first sampling signal and a second sampling signal among the other sampling signals are equivalent to each other and generating an output bit of 1 when the first sampling signal and the second sampling signal are different from each other; and generating a plurality of output bits by performing the generating the output bit the number of times of the number of the other sampling signals.

The sum result of the comparison results is a sum result of the plurality of output bits.

The control method further includes adding a reference phase unit to the present reference phase signal by being synchronized with the reference clock signal to update a reference phase signal, and the reference phase unit is an increase unit of the reference phase signal.

A digital DC-DC converter according to another exemplary embodiment of the present invention includes a DC-DC converter including a power switch that controls conversion of an input voltage to an output voltage, a digital PWM generating a control signal that controls switching operation of the power switch according to an error phase signal, and the controller.

According to the exemplary embodiments of the present invention, a digital DC-DC converter can be formed of a further simple circuit, and a control circuit that reduces the size of the control circuit, a control method, and a digital DC-DC converter using the same are provided.

### BRIEF DESCRIPTION OF THE DRAWINGS

FIG. 1A shows a control circuit according to an exemplary embodiment of the present invention and a digital DC-DC converter using the control circuit.

FIG. 1B shows a division unit and a sampling unit according to the exemplary embodiment of the present invention in detail.

FIG. 2 shows an error generation unit according to the exemplary embodiment of the present invention.

FIG. 3 is a waveform diagram of signals used in a control method according to the exemplary embodiment of the present invention.

FIG. 4 is a waveform diagram of signal used in a control method according to the exemplary embodiment of the present invention when an output voltage is higher than a target value.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

In an exemplary embodiment of the present invention, an output voltage of a digital DC-DC converter is converted to a digital signal and a predetermined number of clock signals is sequentially generated according to the converted digital signal. In this case, a frequency of the clock signal is increased or decreased according to the digital signal converted from the output voltage. For example, the frequency of the clock signal is increased as the output voltage is increased, and the frequency of the clock signal is decreased as the output voltage is decreased.

In the exemplary embodiment of the present invention, a plurality of clock signals are generated with a predetermined phase difference. A reference clock signal is a clock signal that determines an operation frequency of a controller according to the exemplary embodiment of the present invention. For example, a phase signal is generated with one cycle (hereinafter, a reference cycle) unit of the reference clock signal in the exemplary embodiment of the present invention. The phase signal is a signal indicating feedback information of the output voltage.

In the exemplary embodiment of the present invention, a result of counting a first clock signal among the plurality of clock signals is generated. In the exemplary embodiment of the present invention, other clock signals (i.e., clock signals excluding the first clock signal among the plurality of clock signals) are not counted.

However, a method for modulating frequencies of the plurality of clock signals is used to calculate a difference between the count result of the first clock signal and count results of other clock signals in the exemplary embodiment of the present invention. A difference between the first count result and each of the count results is referred to as a phase error.

In further detail, phase errors can be calculated using a plurality of low clock signals, each having a half of frequency of the plurality of clock signals. A sum result of the phase errors is divided with the number of plurality of clock signals, and the division result is subtracted from the first count result such that the phase signal is generated.

In the exemplary embodiment of the present invention, the count result is generated using only the first clock signal, and count results using the respective other clock signals are not generated. According to the exemplary embodiment of the present invention, frequencies of other clock signals are reduced to the halves respectively such that phase errors with a first count result can be generated. This will be described in further detail later.

For example, when an increase unit (hereinafter, a reference phase unit) of a reference phase signal is 3.25, 4 clock signals are required to count a reference cycle with a unit of 0.25 (¼) in the exemplary embodiment of the present invention. The reference phase signal implies a phase signal for maintaining an output voltage with a target voltage. For example, when the phase signal is the same as a reference phase signal, the output voltage is a target voltage, when the phase signal is smaller than the reference phase signal, the output voltage is lower than the target voltage, and when the phase signal is greater than the reference phase signal, the output voltage is higher than the target voltage.

Alternatively, 8 clock signals are required to control the reference cycle with a unit of 0.125 (⅛) when the reference phase unit is 3.125.

It is assumed that, when the reference phase signal is 3.25, a count result of the reference cycle with the first clock signal is and each of the other three clock signals has an error of 1 with respect to the first clock signal. Then, a result obtained by dividing a sum result (i.e., 3) of the errors with the number of plurality of clock signals (i.e., 4) is 0.5, and when a phase signal is generated by subtracting 0.75 from the count result (i.e., 4) of the reference cycle with the first clock signal, the phase signal has a value of 3.25.

Since the reference phase signal and the phase signal are equivalent to each other, the output voltage is maintained with the target voltage. Then, the switching duty can be maintained.

It is assumed that, when the reference phase signal is 6.5, a count result of the reference cycle with the first clock signal is 7, one of the other three clock signals has an error of 1 with respect to the first clock signal and two of the other clock signals have the same phase of the first clock signal. Then, a value obtained by dividing the sum result (i.e., 1) of the errors with the number of plurality of clock signals (i.e., 4) is 0.25, and when a phase signal is generated by subtracting 0.25 from the count result (i.e., 7) of the reference cycle of the first clock signal, the phase signal has a value of 6.75.

Since the phase signal is greater than the reference phase signal, the output voltage is higher than the target voltage. Then, the switching is decreased.

The exemplary embodiment of the present invention will be described in further detail with reference to the accompanying drawings.

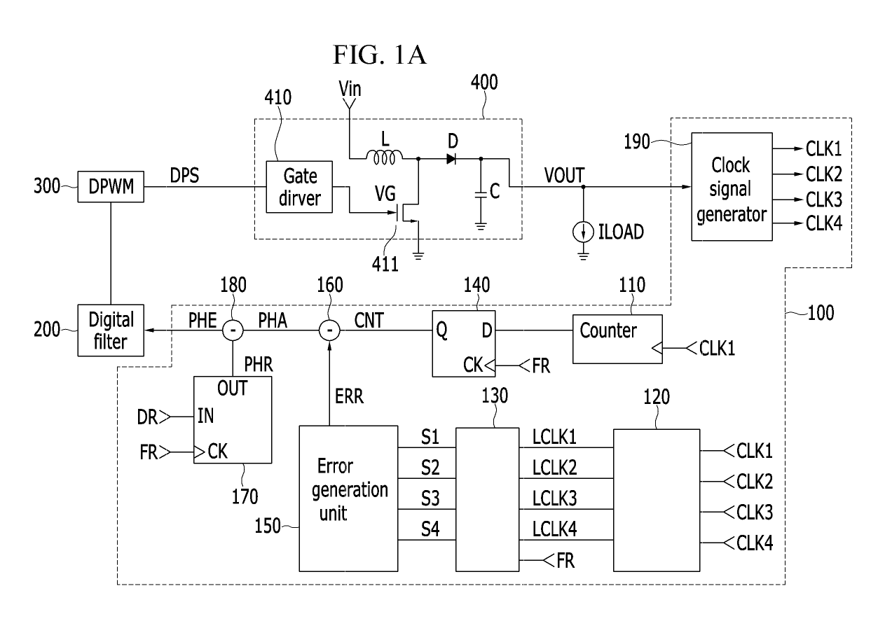

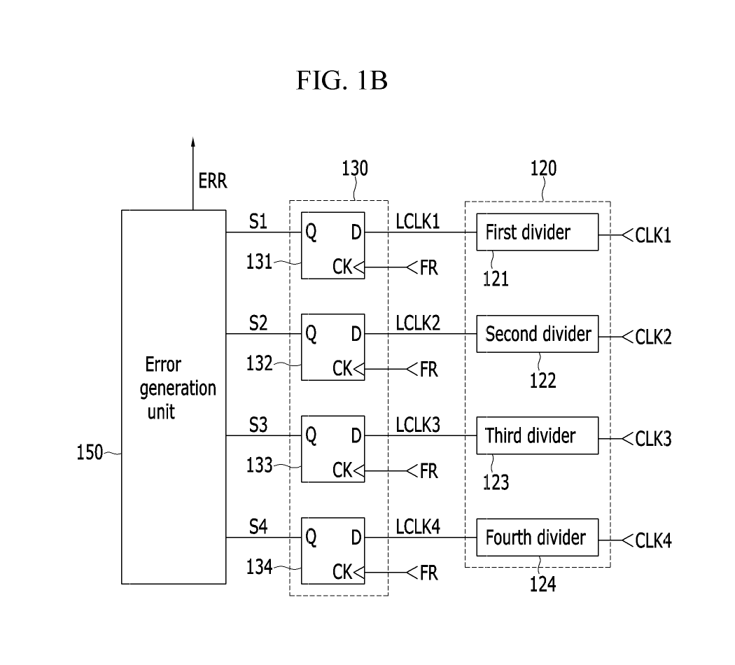

FIG. 1A shows a control circuit according to an exemplary embodiment of the present invention and a digital DC-DC converter using the control circuit.

FIG. 1B shows a division unit and a sampling unit according to the exemplary embodiment of the present invention.

A control circuit 100 generates a plurality of clock signals, each having a frequency according to an output voltage VOUT, generates a phase signal PHA using a result of counting a first clock signal CLK1 among the plurality of clock signal, and generates an error phase signal PHE that is a difference between a reference phase signal PHR and the phase signal PHA. The control circuit 100 generates the reference phase signal PHR by adding a reference phase unit DR (i.e., 3.25 in the previous description) every time that one cycle of the reference clock signal FR is elapsed.

The control circuit 100 includes a counter 110, division unit 120, a sampling unit 130, a count sampler 140, an error generation unit 150, a first subtractor 1600, a reference phase generator 170, a second subtractor 180, and a clock signal generator 190.

The clock signal generator 190 generates a plurality of clock signals, each having a frequency according to an output voltage VOUT. The clock signal generator 190 sets a frequency that is linearly proportional to the output voltage VOUT, and generates the plurality of clock signals according to the set frequencies with a predetermined phase difference.

For example, the clock signal generator 190 may be realized as a voltage controlled oscillator based on an analog-digital (AD) converter.

A reference phase unit according to the exemplary embodiment of the present invention is assumed to be 3.25, and the clock signal generator 190 sets to generate four clock signals CLK1 to CLK3. However, the present invention is not limited thereto, and the number of clock signals generated by the clock signal generator 190 is determined by the reference phase unit.

In further detail, when the number of bits to express digits after the decimal point of the reference phase signal is n, the number of clock signals for counting the digits is 2̂n. For example, when the reference phase unit is 3.25, digits after the decimal point of the reference phase signal are 0, 0.25, 0.5, and 0.75. Thus, the number of bits and clocks for expression of four types of digits after the decimal point are respectively 2 bit and 4.

When the reference phase unit is 3.125, digits after the decimal point of the reference phase signals are 0, 0.125, 0.25, 0.375, 0.5, 0.625, 0.75, and 0.875. Thus, the number of bits and clocks for expression of eight types of digits after the decimal point of are respectively 3 bit and 8.

The counter 110 counts a rising edge (or, a falling edge) of the first clock signal CLK1. The first clock signal CLK1 is a clock signal having the earliest phase among the plurality of clock signals generated from the clock signal generator 190.

The count sampler 140 samples a count result of the counter 110 by being synchronized with a reference clock signal FR to generate a count signal CNT. For example, the count sampler 140 generates the count signal CNT by sampling the count result input to an input terminal D thereof at a rising edge time of the reference clock signal FR input to a clock terminal CK, and outputs the count signal CNT through an output terminal Q.

The division unit 120 generates first to fourth low clock signals LCKL1 to LCLK4 by dividing a frequency of each of the first to fourth clock signals CLK1 to CLK4 to the half. As previously stated, the first to fourth low clock signals LCLK1 to LCLK4 are required to generate phase errors.

A count result (i.e., first count result) using the first clock signal CLK1 and a count result (i.e., second count result) using the second clock signal CLK2 may be equal to or smaller than the first count result. A count result (i.e., third count result) using the third clock signal CLK3 may be equal to or smaller than the first count result. A count result (i.e., fourth count result) using the fourth clock signal CLK4 may be equal to or smaller than the first count result. Since the first clock signal CLK1 has the earliest phase, no count result is greater than the first count result.

Accordingly, the phase errors can be generated without generating the count results using the second to fourth clock signals CLK. In further detail, only the last bit of each of the second to fourth count results is predicted, and when the last bit is equivalent to the last bit of the first count result, the second to fourth count results are supposed to be equal to the first count result, and when the last bit is not equivalent to the last bit of the first count result, the corresponding count result is supposed to be smaller by one than the first count result.

In order to compare the last bit of the first count result with the last bit of each of the second to fourth count results, the first to fourth low clock signals LCLK1 to LCLK4 are generated by dividing the frequency of each of the first to fourth clock signals CLK1 to CLK4 to the half, and logic values of the first low clock signal LCLK1, the second low clock signal LCLK2, the third low clock signal LCLK3, and the fourth low clock signal LCLK4 are compared for each cycle of the reference clock signal FR.

As shown in FIG. 1B, the division unit 120 includes first to fourth dividers 121 to 124. The first divider 121 generates the first low clock signal LCLK1 by dividing the frequency of the first clock signal CLK1 to the half. The second divider 122 generates the second low clock signal LCLK2 by dividing the frequency of the second clock signal CLK2 to the half. The third divider 123 generates the third low clock signal LCLK3 by dividing the frequency of the third clock signal CLK3 to the half. The fourth divider 124 generates the fourth low clock signal LCLK4 by dividing the frequency of the fourth clock signal CLK4 to the half.

As shown in FIG. 1B, the sampling unit 130 samples each of the first to fourth low clock signals LCLK1 to LCLK4 by being synchronized with the reference clock signal FR. In further detail, the sampling unit 130 samples each of the first to fourth low clock signals LCLK1 to LCLK4 at the rising edge of the reference clock signal FR to generate first to fourth sampling signals S1 to S4.

The sampling unit 130 includes four samplers 131 to 134. Each of the four samplers 131 to 134 includes a clock terminal CK to which the reference clock signal FR is input, an input terminal D to which the corresponding low clock signal among the first to fourth low clock signals LCLK1 to LCLK4 is input, and an output terminal Q. The corresponding sampling signal is output from the output terminal Q of each of the four samplers 131 to 134.

The error generation unit 150 receives the first to fourth sampling signals S1 to S4, generates phase errors according to comparison results of the second to fourth sampling signals S2 to S4 with reference to the first sampling signal S1, and generates an average phase error ERR by dividing the sum of the phase errors with the number of plurality of clock signals.

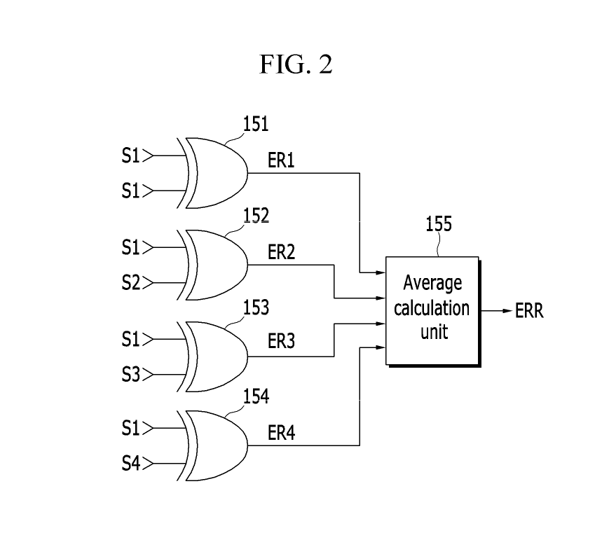

FIG. 2 shows the error generator according to the exemplary embodiment of the present invention.

The error generation unit 150 includes first to fourth XOR gates 151 to 154 and an average calculation unit 155. According to an XOR operation result, two equivalent inputs of the XOR gate output 0 bit and two different inputs output 1 bit.

The first XOR gate 151 performs XOR operation on the first sampling signal S1 and the first sampling signal S1. Since the XOR operation is performed on the equivalent signals, an error bit ER1 output from the first XOR gate 151 is always 0.

The second XOR gate 152 performs XOR operation on the first sampling signal S1 and the second sampling signal S2, the third XOR gate 153 performs XOR operation on the first sampling signal S1 and the third sampling signal S3, and the fourth XOR gate 154 performs XOR operation on the first sampling signal S1 and the fourth sampling signal S4.

First to fourth output bits ER1 to ER4 respectively output from the first to fourth XOR gates 151 to 154 are transmitted to the average calculation unit 155.

The average calculation unit 155 adds the first to fourth output bits ER1 to ER4, and then calculates an average by the sum with the number of plurality of clock signals. The calculated average is an average phase error ERR.

The first XOR gate 151 generates always outputs 0 bit, and therefore the exemplary embodiment of the present invention may not include the first XOR gate 151.

The first subtractor 1600 generates a phase signal PHA by subtracting the average phase error ERR from the count signal CNT.

The reference phase generator 170 is synchronized with the rising edge of the reference clock signal FR and thus generates the reference phase signal PHR for each cycle of the reference clock signal FR by adding a reference phase unit DR to the present reference phase signal PHR.

The reference phase generator 170 includes a clock terminal to which the reference clock signal FR is input, an input terminal IN to which the reference phase unit DR is input, and an output terminal OUT. The reference phase generator 170 outputs the reference phase signal PHR through the output terminal OUT.

The second subtractor 180 generates an error phase signal PHE by subtracting the reference phase signal PHR from the phase signal PHA.

The digital filter 200 filters the error phase signal PHE and transmits the filtered signal to a digital pulse width modulator (DPWM) 300.

The DPWM 300 generates a control signal DPS that controls switching duty of the DC-DC converter 400 according to the error phase signal PHE. Since the error phase signal PHE is high when the output voltage VOUT is high compared to a target value, the DPWM 300 generates the control signal DPS to decrease the switching duty. Then, the error phase signal PHE is decreased, and the output voltage VOUT reaches the target value.

The DC-DC converter 400 generates the output voltage VOUT by performing switching operation according to the control signal DPS. In the exemplary embodiment of the present invention, the DC-DC converter 400 exemplarily realized as a boost converter. However, the present invention is not limited thereto.

The DC-DC converter 400 includes a gate driver 410 generating a gate voltage VG according to the control signal DPS.

A power switch 411 performing the switching operation according to the gate voltage VG is connected between an inductor L and a ground. The input voltage Vin is connected to a first terminal of the inductor L, and a second terminal of the inductor L is connected to the power switch 411 and an anode of a rectification diode D.

A capacitor C is connected to a cathode of the rectification diode D, and the capacitor C reduces ripple of the output voltage VOUT.

Energy is stored in the inductor L during a turn-on period of the power switch 411, and the output voltage VOUT is supplied to a load ILOAD from the energy stored in the inductor L through the rectification diode D during a turn-off period of the power switch 411.

When the switching duty is increased, the energy stored in the inductor L is increased and thus the output voltage VOUT is increased. In the opposite case, the output voltage VOUT is decreased.

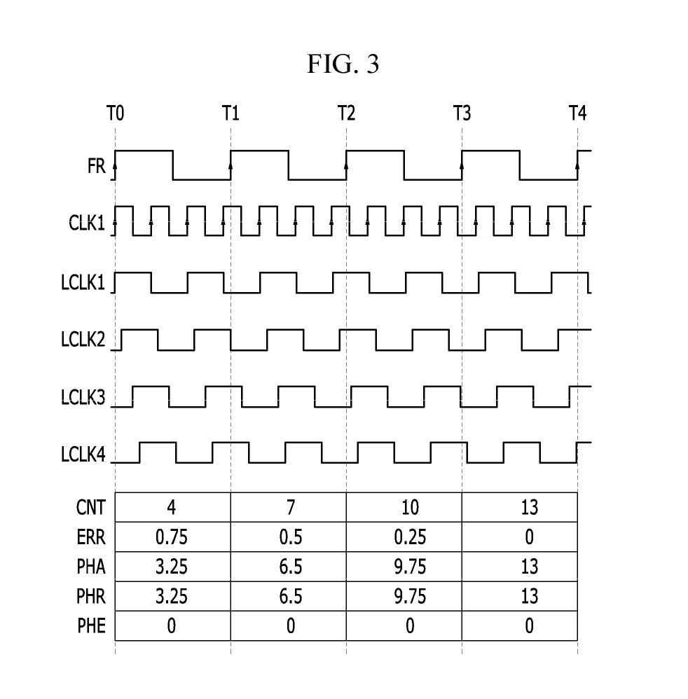

Hereinafter, a control method according to the exemplary embodiment of the present invention will be described with reference to FIG. 3.

FIG. 3 is a waveform diagram of signals used in the control method according to the exemplary embodiment of the present invention. The waveform diagram of FIG. 3 illustrates signals generated in a condition that the output voltage is maintained with a target value.

In FIG. 3, it is assumed that the first clock signal CLK1 is generated from the first rising edge time point T0 of the reference clock signal FR. However, the present invention is not limited thereto.

At a time point T1, the second rising edge of the reference clock signal FR is generated, and the count sampler 140 generates the count signal CNT by sampling a count result at the time point T1.

In this case, the count result of the first clock signal CLK1 during a period from the time point T0 to the time point T1 by the counter 110 is 4, and therefore that count signal CNT is 4. In further detail, the counter 110 according to the exemplary embodiment of the present invention counts a rising edge of the first clock signal CLK1.

The first to fourth low clock signals LCLK1 to LCLK4 output from the first to fourth dividers 121 to 124 are sampled by the first to fourth sampler 131 to 134 at the time point T1 so that the first to fourth sampling signals S1 to S4 are generated. In this case, the first sampling signal S1 is 0 and the second to fourth sampling signals S2 to S4 are 1.

Since the first sampling signal S1 and the second to fourth sampling signals S2 to S4 are different from each other, the second to fourth output bits ER2 to ER4 are 1, and the sum, i.e., 3 of the output bits is divided by 4 such that 0.75 average phase error ERR is generated.

The 0.75 average phase error ERR is subtracted from the count signal CNT 4 such that the phase signal PHA becomes 3.25. Since the reference phase signal PHR is 3.24 at the time point T1, the error phase signal PHE becomes 0. Accordingly, the switching duty is maintained.

Next, at a time point T2, the third rising edge of the reference clock signal FR is generated, and the count sampler 140 generates the count signal CNT by sampling the count result at the time point T2.

Since the count result of the first clock signal CLK1 during a period from the time point T0 to the time point T2 by the counter 110 is 7, the count signal CNT is 7.

The first to fourth low clock signals LCLK1 to LCLK4 output from the first to fourth dividers 121 to 124 are sampled by the first to fourth samplers 131 t-134 at the time point T2 so that the first to fourth sampling signals S1 to S4 are generated. In this case, the first sampling signal S1 and the second sampling signal S2 are 1, and the third sampling signal S3 and the fourth sampling signal S4 are 0.

Since the first sampling signal S1 is different from the third and fourth sampling signals S3 and S4, the third and fourth output bits ER3 and ER4 are 1, the first and second output bits Er1 and ER2 are 0, and the sum result (i.e., 2) is divided by 4 such that the average phase error ERR becomes 0.5.

The 0.5 average phase error ERR is subtracted from the count signal CNT 7 such that phase signal PHA becomes 6.5. Since the reference phase signal PHR is 6.5 at the time point T2, the error phase signal PHE becomes 0. Accordingly, the switching duty is maintained.

At a time point T3, the count signal CNT is 10, the first to third sampling signals S1 to S3 are 1, and the fourth sampling signal S4 is 0. Since the first sampling signal S1 and the fourth sampling signal S4 are different from each other, the fourth output bit ER4 is 1, the first to third output bits ER1 to ER3 are 0, and the sum of the output bits, i.e., 1 is divided by 4 such that the average phase error ERR becomes 0.25.

The 0.25 average phage error ERR is subtracted from the count signal CNT 10 such that the phase signal PHA becomes 9.75. Since the reference phase signal PHR is 9.75 at the time point T3, the error phase signal PHE becomes 0. Accordingly, the switching duty is maintained.

At a time point T4, the count signal CNT is 13, and the first to fourth sampling signals S1 to S4 become 1. Since the first sampling signal S1 is equivalent to the second to fourth sampling signals S2 to S4, the first to fourth output bits ER1 to ER4 become 0. Accordingly, the average phase error ERR becomes 0.

The count signal CNT 13 becomes the phase signal PHA 13, and the reference phase signal PHR is 13 at the time point T4, and thus the error phase signal PHE becomes 0. Accordingly, the switching duty is maintained.

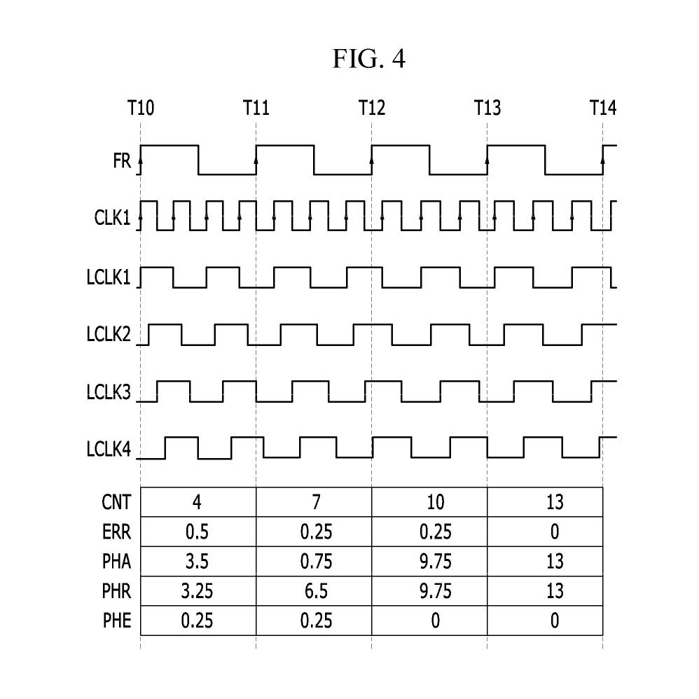

Hereinafter, a case that the output voltage VOUT is higher than a target value will be described with reference to FIG. 4.

FIG. 4 is a waveform diagram of signals used in the control method according to the exemplary embodiment of the present invention when the output voltage is higher than the target value.

In FIG. 4, it is assumed that the first clock signal CLK1 is generated from the first rising edge T10 of the reference clock signal FR. However, the present invention is not limited thereto.

At a time point T11, the second rising edge of the reference clock signal FR is generated, and the count sampler 140 generates the count signal CNT by sampling the count result at the time T11.

In this case, since the count result of the first clock signal CLK1 during a period from the time point T10 to the time point T11 by the counter 110 is 4, the count signal CNT is 4. In further detail, the counter 110 according to the exemplary embodiment of the present invention counts a rising edge of the first clock signal CLK1.

The first to fourth low clock signals LCLK1-LCLK4 output from the first to fourth dividers 121 to 124 are sampled by the first to fourth samplers 131 to 134 at the time point T11 such that the first to fourth sampling signals S1 to S4 are generated. In this case, the first sampling signal S1 and the second sampling signal S2 are 0, and the third sampling signal S3 and the fourth sampling signal S4 are 1.

Since the first sampling signal S1 is different from the third and fourth sampling signals S3 and S4, the first and second output bits ER1 and ER2 are 0, the third and fourth output bits ER3 and ER4 are 1, and the sum result, i.e., 2 is divided by 4 such that the average phase error ERR of 0.5 is generated.

The average phase error ERR, i.e., 0.5 is subtracted from the count signal CNT, i.e., 4 and thus the phase signal PHA becomes 3.5. Since the reference phase signal PHR is 3.25 at the time point T1, the error phase signal PHE becomes 0.25. Then, the DPWM 300 generates a control signal DPS to decrease switching duty, and the DC-DC converter 400 decreases the switching duty according to the control signal DPS. The output voltage VOUT is decreased according to the decrease of the switching duty.

As shown in FIG. 4, compared to before the time point T11, the frequency of the first clock signal CLK1 is decreased after the time point T11 due to the decrease of the output voltage VOUT.

Then, at a time point T12, the third rising edge of the reference clock signal FR is generated, and the count sampler 140 generates the count signal CNT by sampling the count result at the time point T12.

Since the count result of the first clock signal CLK1 during a period from the time point T10 to the time point T12 by the counter 110 is 7, the count signal CNT is 7.

The first to fourth low clock signals LCLK1-LCLK4 output from the first to fourth dividers 121 to 124 are sampled by the first to fourth samplers 131 to 134 at the time point T12 such that the first to fourth sampling signals S1 to S4 are generated. In this case, the first to third sampling signals S1 and S3 are 1, and the fourth sampling signal S4 is 0.

Since the first sampling signal S1 and the fourth sampling signal S4 are different from each other, the fourth output bit ER4 is 1, the first to third output bits ER1 to ER3 are 0, and the sum result, i.e., 1 is divided by 4 such that the average phase error ERR of 0.25 is generated.

The average phase error ERR of 0.25 is subtracted from the count signal CNT, i.e., 7 and thus the phase signal PHA becomes 6.75. Since the reference phase signal PHR is 6.5 at the time point T12, the error phase signal PHE becomes 2.5. Then, the DPWM 300 generates the control signal DPS that decreases the switching duty, and the DC-DC converter 400 decreases the switching duty according to the control signal DPS. The output voltage VOUT is decreased according to the decrease of the switching duty.

As shown in FIG. 4, compared to before the time point T12, the frequency of the first clock signal CLK1 is decreased after the time point T12 due to the decrease of the output voltage VOUT.

At a time point T13, the count signal CNT is 10, the first to third sampling signals S1 to S3 are 0, and the fourth sampling signal S4 is 1. Since the first sampling signal S1 and the fourth sampling signal S4 are different from each other, the fourth output bit ER4 is 1, the first to third output bits ER1 to ER3 are 0, and the sum result, i.e., 1 is divided by 4 such that the average phase error ERR of 0.25 is generated.

The average phase error ERR of 0.25 is subtracted from the count signal CNT, i.e., 10 and thus the phase signal PHA becomes 9.75. Since the reference phase signal PHR is 9.75 at the time point T13, the error phase signal PHE becomes 0. Accordingly, the switching duty is mainted.

At a time point T14, the count signal CNT is 13 and the first to fourth sampling signals S1 to S4 are 1. Since the first sampling signal S1 is equivalent to the second to fourth sampling signals S2 to S4, the first to fourth output bits ER1 to ER4 are 0. Accordingly, the average phase error ERR becomes 0.

The count signal CNT, i.e., 13 becomes the phase signal PHA, i.e., 13, and the reference phase signal PHR is 13 at the time point T14, and therefore the error phase signal PHE becomes 0. Accordingly, the switching duty can be maintained.

As described, according to the exemplary embodiment of the present invention, a counter circuit large in size to count a plurality of clock signals is not need to be provided in plural. Only one counter counting a first clock signal having the earliest phase is required.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

control circuit 100, counter 110, division unit 120, sampling unit 130
count sampler 140, error generation unit 150, first subtractor 1600
reference phase generator 170, second subtractor 180, clock signal generator 190
first to fourth divider (121-124), sampler (131-134)
first to the fourth XOR gate (151-154), average calculation unit 155, digital filter 200
digital pulse width modulator (DPWM) 300, DC-DC converter 400
gate driver 410, power switch 411, inductor (L)
Rectification diode (D), capacitor (C)

What is claimed is:

1. A controller comprising:
a clock signal generation unit configured to generate a plurality of clock signals, each of the plurality of clock signals having a frequency according to an output voltage;
a division unit configured to generate a plurality of low clock signals, wherein each of the plurality of low clock signals corresponds to an associated one of the plurality of clock signals and has a frequency half of the frequency of the corresponding clock signal; and
a first subtractor configured to generate a phase signal corresponding to the output voltage based on subtraction of an average phase error from a count signal associated with at least one of the plurality of clock signals,
wherein said count signal is generated based on a sampling of a count result associated with a first clock signal synchronized with a reference clock signal from the count result of a first clock signal having the earliest phase among the plurality of clock signals,
wherein the average phase error is generated based on a comparison of a first low clock signal corresponding to the first clock signal with each of the plurality of low clock signals synchronized with the reference clock signal.

2. The controller of claim 1, further comprising a second subtractor configured to generate an error phase signal based on subtraction of a reference phase signal corresponding to a target value of the output voltage from the phase signal.

3. The controller of claim 1, wherein, when the number of bits for expression of digits after the decimal point of the reference phase signal is n, the number of the plurality of clock signals is 2̂n.

4. The controller of claim 1, further comprising:
a counter configured to count the first clock signal, and
a count sampler configured to sample the count result output from the counter by being synchronized with the reference clock signal to generate the count signal.

5. The controller of claim 1, further comprising:
a sampling unit configured to sample the plurality of low clock signals by being synchronized with the reference clock signal to generate a plurality of sampling signals, each of the plurality of sampling signals corresponding to an associated one of the plurality of low clock signals, and
an error generation unit configured to receive the plurality of sampling signals and generate phase errors for each of the plurality of sampling signals based on a comparison of a first sampling signal corresponding to the first low clock signal with each of the other plurality of sampling signals, the error generation unit configured to generate the average phase error based on division of a sum of the generated phase errors by the number of the plurality of clock signals.

6. The controller of claim 5, wherein the error generation unit comprises:
a plurality of XOR gates, each of the plurality of XOR gates configured to receive the first sampling signal and a different one of the plurality of sampling signals and further configured to generate an out bit having a value of 0 when the two sampling signal inputs are equivalent to each other and 1 when the two sampling signal inputs are different from each other; and
an average calculation unit configured to generate the average phase error by dividing a sum result of the out bits generated by each of the plurality of XOR gates by the number of the plurality of clock signals.

7. The controller of claim 1, further comprising a reference phase generator synchronized with the reference clock signal and configured to update a reference phase signal based on addition of a reference phase unit to the present reference phase signal,
wherein the reference phase unit is an increase unit of the reference phase signal.

8. A control method comprising:
generating a plurality of clock signals, each of the plurality of clock signals having a frequency according to an output voltage;
generating a count signal by sampling a count result of a first clock signal having the earliest phase among the plurality of clock signals by being synchronized with a reference clock signal;
generating a plurality of low clock signals, each of the plurality of low clock signals corresponding to an associated one of the plurality of clock signals and having a frequency half of the frequency of the corresponding clock signal;
generating an average phase error based on a comparison result of a first low clock signal corresponding to a first clock signal with each of the plurality of low clock signals by being synchronized with the reference clock signal; and
generating a phase signal corresponding to the output voltage by subtracting the average phase error from a count signal.

9. The control method of claim 8, further comprising generating an error phase signal by subtracting a reference phase signal corresponding to a target value of the output voltage from the phase signal.

10. The control method of claim 8, wherein, when the number of bits for expression of digits after the decimal point of the reference phase signal is n, the number of plurality of clock signals is 2̂n.

11. The control method of claim 8, wherein the generating the average phase error comprises:
generating a plurality of sampling signals by sampling the plurality of low clock signals by being synchronized with the reference clock signal;
comparing a first sampling signal corresponding to the first low clock signal with each of the other-plurality of sampling signals; and
generating the average phase error by dividing a sum result of the comparison results by the number of the plurality of clock signals.

12. The control method of claim 11, wherein the comparing the first sampling signal with each of the other sampling signals comprises:
generating an output bit of 0 when the first sampling signal and a second sampling signal among the other plurality of sampling signals are equivalent to each other and generating an output bit of 1 when the first sampling signal and the second sampling signal are different from each other, and
generating a plurality of output bits based on the number of the plurality of the sampling signals.

13. The control method of claim 12, wherein the sum result of the comparison results is a sum result of the plurality of output bits.

14. The control method of claim 8, further comprising adding a reference phase unit to the present reference phase signal by being synchronized with the reference clock signal to update a reference phase signal,
wherein the reference phase unit is an increase unit of the reference phase signal.

15. A digital DC-DC converter including a power switch that controls operation for converting an input voltage to an output voltage, comprising:
a digital pulse width modulator (PWM) generating a control signal configured to generate switching operation of the power switch according to an error phase signal; and
a controller configured to generate a plurality of clock signals, each of the plurality of clock signals having a frequency according to an output voltage, to generate a plurality of low clock signals, each of the plurality of low clock signals corresponds to an associated one of the plurality of clock signals and has a frequency half of the frequency of the corresponding clock signal, to generate a phase signal corresponding to the output voltage based on subtraction of an average phase error from a count signal associated with at least one of the plurality of clock signals, wherein said count signal is generated based on a sampling of a count result associated with a first clock signal having the earliest phase among the plurality of clock signals by being synchronized with a reference clock signal, and to generate an error phase signal based on subtraction of a reference phase signal corresponding to a target value of the output voltage from the phase signal,
wherein the average phase error is generated based on a comparison of a first low clock signal corresponding to the first clock signal with each of the plurality of low clock signals synchronized with the reference clock signal.

16. The digital DC-DC converter of claim 15, wherein, when the number of bits for expression of digits after the decimal point of the reference phase signal is n, the number of plurality of clock signals is 2̂n.

17. The digital DC-DC converter of claim 15, wherein the controller comprises:
a counter configured to count the first clock signal; and
a count sampler configured to sample the count result output from the counter by being synchronized with the reference clock signal to generate the count signal.

18. The digital DC-DC converter of claim 15, wherein the controller comprises:
a sampling unit configured to sample the plurality of low clock signals by being synchronized with the reference clock signal to generate a plurality of sampling signals, each of the plurality of sampling signals corresponding to an associated one of the plurality of low clock signals; and
an error generation unit configured to receive the plurality of sampling signals and generate phase errors for each of the plurality of sampling signals based on a comparison of a first sampling signal corresponding to the first low clock signal with each of the other plurality of sampling signals, the error generation unit configured to generate the average phase error based on division of a sum of the generated phase errors by the number of the plurality of clock signals.

19. The digital DC-DC converter of claim 18, wherein the error generation unit comprises:
a plurality of XOR gates, each of the plurality of XOR gates configured to receive the first sampling signal and a different one of the plurality of sampling signals and further configured to generate an out bit having a value of 0 when the two sampling signal inputs are equivalent to each other and 1 when the two sampling signal inputs are different from each other, and
an average calculation unit configured to generate the average phase error by dividing a sum result of the out bits generated by each of the plurality of XOR gates by the number of plurality of clock signals.

20. The digital DC-DC converter of claim 19, further comprising a reference phase generator synchronized with the reference clock signal and configured to update a reference phase signal based on addition of a reference phase unit to the present reference phase signal,
wherein the reference phase unit is an increase unit of the reference phase signal.
